(19) United States
(12) Patent Application Publication
(10) Pub. No.: US 2010/0036809 A1
(43) Pub. Date: Feb. 11, 2010

(54) TRACKING MARKET-SHARE TRENDS BASED ON USER ACTIVITY

(75) Inventors: David Gerster, Burlingame, CA (US); Amr Awadallah, Palo Alto, CA (US); Sajjit Thampy, Sunnyvale, CA (US)

Correspondence Address: BAKER BOTTS L.L.P., 2001 ROSS AVENUE, 6TH FLOOR, DALLAS, TX, 75201, US

(73) Assignee: YAHOO! INC., Sunnyvale, CA (US)

(21) Appl. No.: 12/187,236

(22) Filed: Aug. 6, 2008

(51) Int. Cl. G06F 7/06; G06F 17/30

(52) U.S. Cl. 707/3; 707/E17.108

(57) ABSTRACT

A method of determining market-share trends includes: specifying values for switching between pairs of search tools for a user; determining values for a transition matrix between the search tools from the switching values; determining steady-state values from the transition matrix for characterizing a steady state arising from a sequential operation of the transition matrix, wherein the steady-state values characterize market-share trends for the search tools; and saving one or more values for the steady state values.

### BACKGROUND OF THE INVENTION

1. Field of Invention

The present invention relates to modeling trend generally and more particularly to tracking market-share trends based on user activity at multiple Internet sites.

2. Description of Related Art

Tracking online market-share trends is critical to business operations for large Internet portals like Yahoo! In particular, user preferences for one search engine versus another can have significant effect on related economic models for pricing and profit, and the implications can be pivotal for related product decisions.

In general, the major source of market-share data comes from third party providers (e.g., Internet access providers), typically on a monthly basis. This data has limitations as it could be subject to biases in the manner in which the third party selects its panelists, who may for example carry out independent random surveys on market-share trends. The limited count of the panelists could also make short weekly aggregations of market-share data unreliable.

Alternative sources of potentially more reliable data have recently emerged including software such as the Yahoo! toolbar that provides attractive features to users in exchange for clickstream information that includes activity with other web sites and search engines. However, the useful application of this data has not been developed.

Thus, there is a need for improved methods for tracking market-share trends based on user activity on the Internet.

### SUMMARY OF THE INVENTION

In one embodiment of the present invention, a method of determining market-share trends includes: specifying values for switching between pairs of search tools for a user; determining values for a transition matrix between the search tools from the switching values; determining steady-state values from the transition matrix for characterizing a steady state arising from a sequential operation of the transition matrix, wherein the steady-state values characterize market-share trends for the search tools; and saving one or more values for the steady state values (e.g., saving the steady-state values directly or through some related characterization).

According to one aspect of this embodiment, the search tools may include Internet search engines.

According to another aspect, specifying the switching values may include keeping running counts for switches between pairs of the search tools.

According to another aspect, determining the values for the transition matrix between the search tools may include scaling combinations of the switching values from a first search tool to another one of the search tools by a value for all switches from the first search tool.

According to another aspect, determining the steady-state values may include calculating values for matrix multiplications of the transition matrix and calculating a steady-state condition for terminating the matrix multiplications.

According to another aspect, determining the steady-state values may includes calculating at least one eigenvalue and eigenvector for the transition matrix

According to another aspect, saving the one or more values may include storing the one or more values in a computer-readable medium.

According to another aspect, the method may further include: specifying values for switching between pairs of sites for a plurality of users; determining values for transition matrices between the sites from the switching values for each of the users; determining steady-state values from the transition matrices for characterizing steady states arising from sequential operations of the transition matrices; determining at least one statistical value from the steady-state values between two sites for the users; wherein the at least one statistical value includes one of a mean or median value with respect to the users for transitions from the first of the two sites to the second of the two sites; and saving one or more values for the at least one statistical value.

Additional embodiments relate to an apparatus for carrying out any one of the above-described methods, where the apparatus includes a computer for executing instructions related to the method. For example, the computer may include a processor with memory for executing at least some of the instructions. Additionally or alternatively the computer may include circuitry or other specialized hardware for executing at least some of the instructions. Additional embodiments also relate to a computer-readable medium that stores (e.g., tangibly embodies) a computer program for carrying out any one of the above-described methods with a computer.

In these ways the present invention enables improved methods for tracking market-share trends based on user activity on the Internet.

### BRIEF DESCRIPTION OF THE DRAWINGS

FIG. 1 shows a method of determining market-share trends according to an embodiment of the present invention.

FIG. 2 shows an exemplary state diagram and transition matrix related to the embodiment shown in FIG. 1.

FIG. 3 shows a conventional general-purpose computer.

FIG. 4 shows a conventional Internet network configuration.

### DETAILED DESCRIPTION OF EXEMPLARY EMBODIMENTS

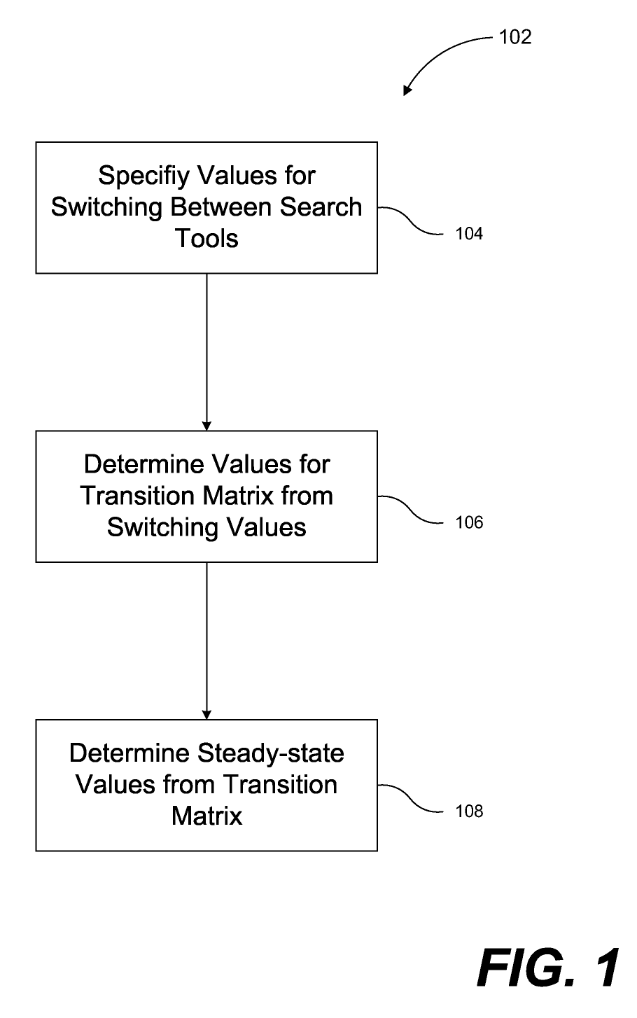

An embodiment of the present invention is shown in FIG. 1. A method 102 of determining market-share trends includes specifying values for switching between pairs of search tools for a user 104; determining values for a transition matrix between the search tools from the switching values 106; and determining steady-state values from the transition matrix 108. As discussed below, the steady-state values, which are based on sequential operation of the transition matrix, characterize market-share trends for the search tools.

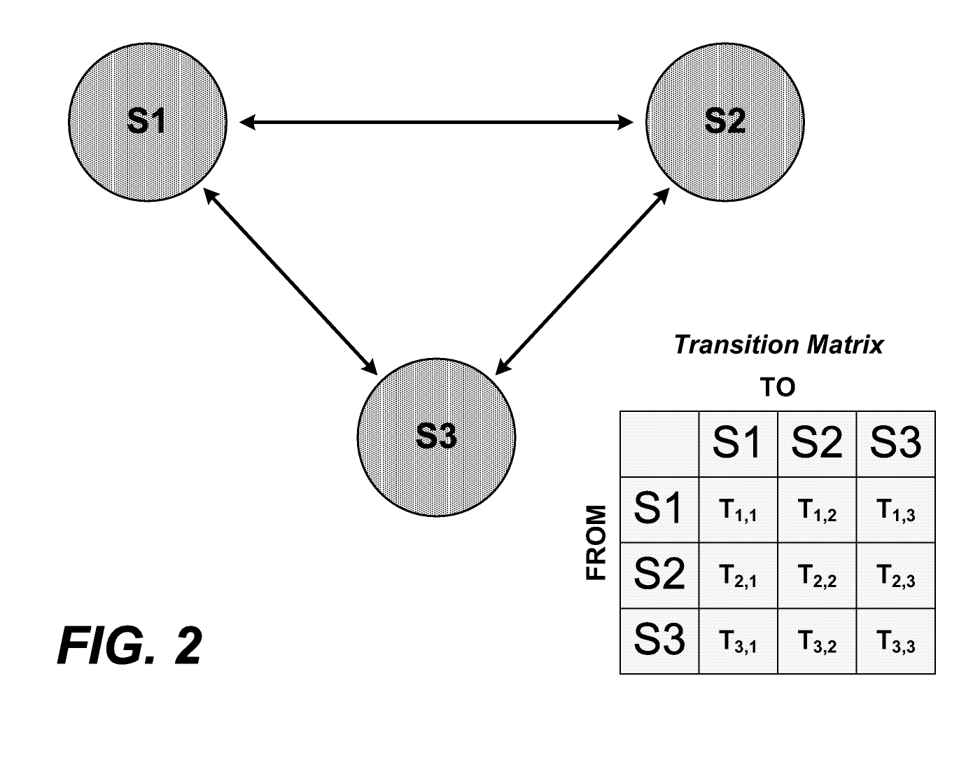

As illustrated in FIG. 2, the search tools can be identified with Internet search engines and their corresponding Internet sites (e.g., Yahoo!). FIG. 2 shows three search tools S1, S2, and S3 and a corresponding 3×3 transition matrix that relates to transitions “from” the row-indexed search tool “to” the column-indexed search tool. In this context the search tools S1, S2, and S3 can be considered as user states corresponding to which search tool is being used (or was last used), and the structures associated with Markov models, stochastic matrices, and eigen-analysis can be used to estimate market-share trends. (See, for example, “Markov chain”, “Stochastic matrix”, and “Eigenvalue, eigenvector, and eigenspace”, from Wikipedia, the free encyclopedia.)

As the user switches between search engines, the user effectively switches states and running counts of these switches can be used to estimate values for the transition matrix. For example, let T_{i,j} represent the probability of a user transitioning from Sᵢ to Sⱼ, where T_{i,j} is

$${T}_{i , j} = \frac{Number of times user transitioned from i to j}{Number of times user transitioned from i}$$

Computing T_{i,j} for all the cells in the transition matrix effectively models the system. In some operational settings this value can be computed on a daily basis for each user that is supplying clickstream information. As there are not many search engines, the resource cost for this is likely to be small. From a given transition matrix, steady-state values can be extracted by a variety of techniques including matrix iteration and eigenvector decomposition. In a preferred embodiment, matrix iterations can be employed for simplicity.

Let M be a transition matrix (e.g., a 3×3 matrix as in FIG. 2). This transition matrix M is an instantaneous snapshot of a user's preferences (e.g., over a day or some other time period) and likely not the long term behavior of that user. The long term behavior of this user is the steady state matrix M^{∞}. To get at the steady state transition matrix, this matrix is multiplied by itself a specified number of times until the cell values (i.e., matrix entries) converge to a limit.

That is, the state transition matrix (M) is repeatedly multiplied in a sequence to obtain higher matrix powers. For example, to accelerate the convergence, the iterations can be carried out as a quadratic iteration:

M^{k+1}←M^{k}·M^{k},

where k denotes the index associated with the iteration.

Although convergence is not guaranteed, the number of iterations can be fixed to a maximum number of times Nₘₐₓ. After every iteration, a check is performed to see if the difference between corresponding individual cells is smaller that some tolerance ε, which is typically set to 0.001 or lower:

|T_{i,j}^{k+1}−T_{i,j}^{k}|<ε,

If there is no convergence by the maximal number of times Nₘₐₓ, then that user's data may be discarded from the analysis. After computing steady state matrices M^{∞} for a number of users, the median value for each cell across users can be time trended or plotted on a daily basis. By examining statistical values across users (e.g., median or mean values of T_{i,j}^{k}) over time, the market trends associated with search tools can be effectively tracked.

As noted above, eigen-analysis can also be used for determining steady state values. For example, if Mu=λu, then Mⁿu=λⁿu, so that λ=1 corresponds to steady state values. (See, for example, “Markov chain”, “Stochastic matrix”, and “Eigenvalue, eigenvector, and eigenspace”, from Wikipedia, the free encyclopedia.)

As a specific example, consider the following transition matrix

$$[ \begin{matrix}0.2 & 0.8 & 0 \\ 0.4 & 0 & 0.6 \\ 0.5 & 0.5 & 0\end{matrix} ]$$

The steady state transition matrix for this matrix is approximately given by:

$$[ \begin{matrix}0.353 & 0.404 & 0.242 \\ 0.353 & 0.404 & 0.242 \\ 0.353 & 0.404 & 0.242\end{matrix} ]$$

In this case, the steady-state values indicate probabilities are independent of the row index (e.g., the initial search engine in the sequence).

At least some values for the results of the method can be output to a user or saved for subsequent use. For example the steady-state values of the matrix cells can be saved directly for applications in tracking market-share trends. Alternatively, some derivative or summary form of the results (e.g., averages, interpolations, etc.) can be saved for later use according to the requirements of the operational setting.

Additional embodiments relate to an apparatus for carrying out any one of the above-described methods, where the apparatus includes a computer for executing computer instructions related to the method. In this context the computer may be a general-purpose computer including, for example, a processor, memory, storage, and input/output devices (e.g., keyboard, display, disk drive, Internet connection, etc.). However, the computer may include circuitry or other specialized hardware for carrying out some or all aspects of the method. In some operational settings, the apparatus may be configured as a system that includes one or more units, each of which is configured to carry out some aspects of the method either in software, in hardware or in some combination thereof. For example, the system may be configured as part of a computer network that includes the Internet. At least some values for the results of the method can be saved, either in memory (e.g., RAM (Random Access Memory)) or permanent storage (e.g., a hard-disk system) for later use.

Additional embodiments also relate to a computer-readable medium that stores (e.g., tangibly embodies) a computer program for carrying out any one of the above-described methods by means of a computer. The computer program may be written, for example, in a general-purpose programming language (e.g., C, C++) or some specialized application-specific language. The computer program may be stored as an encoded file in some useful format (e.g., binary, ASCII).

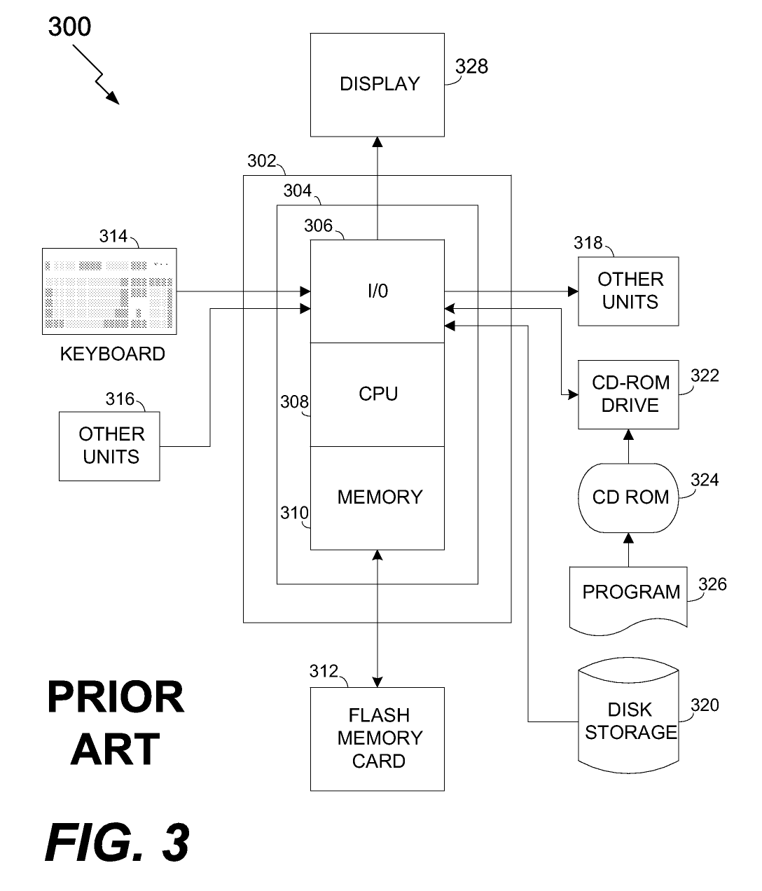

As described above, certain embodiments of the present invention can be implemented using standard computers and networks including the Internet. FIG. 3 shows a conventional general purpose computer 300 with a number of standard components. The main system 302 includes a motherboard 304 having an input/output (I/O) section 306, one or more central processing units (CPU) 308, and a memory section 310, which may have a flash memory card 312 related to it. The I/O section 306 is connected to a display 328, a keyboard 314, other similar general-purpose computer units 316, 318, a disk storage unit 320 and a CD-ROM drive unit 322. The CD-ROM drive unit 322 can read a CD-ROM medium 324 which typically contains programs 326 and other data.

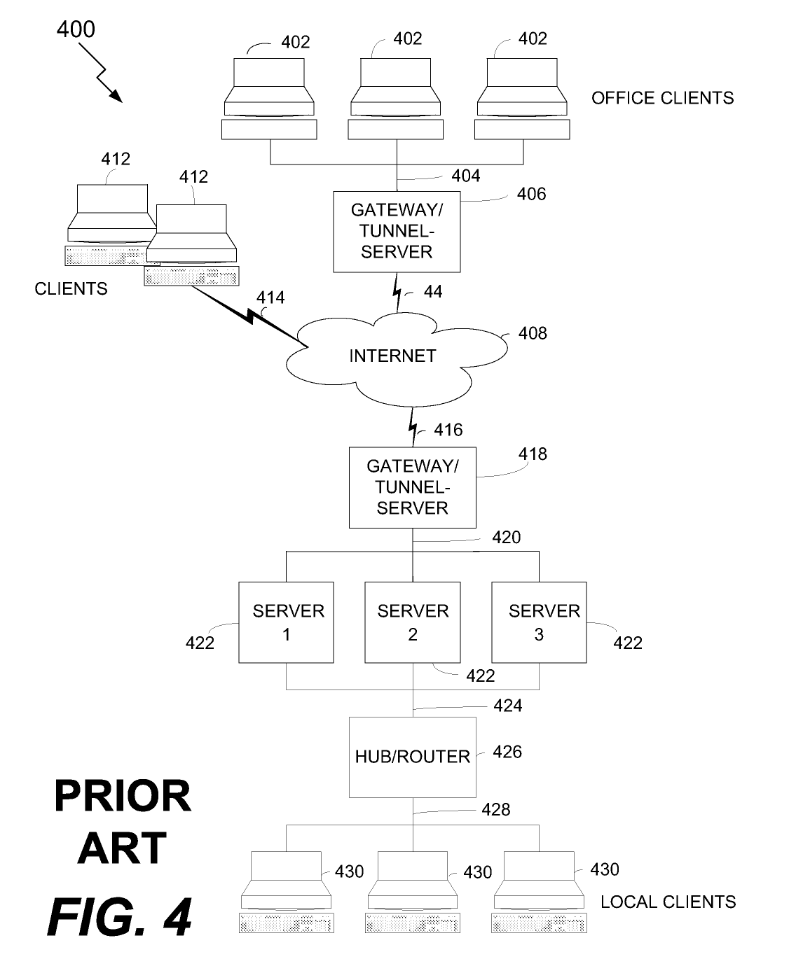

FIG. 4 shows a conventional Internet network configuration 400, where a number of office client machines 402, possibly in a branch office of an enterprise, are shown connected 404 to a gateway/tunnel-server 406 which is itself connected to the Internet 408 via some internet service provider (ISP) connection 410. Also shown are other possible clients 412 similarly connected to the internet 408 via an ISP connection 414. An additional client configuration is shown for local clients 430 (e.g., in a home office). An ISP connection 416 connects the Internet 408 to a gateway/tunnel-server 418 that is connected 420 to various enterprise application servers 422. These servers 422 are connected 424 to a hub/router 426 that is connected 428 to various local clients 430.

Although only certain exemplary embodiments of this invention have been described in detail above, those skilled in the art will readily appreciate that many modifications are possible in the exemplary embodiments without materially departing from the novel teachings and advantages of this invention. For example, aspects of embodiments disclosed above can be combined in other combinations to form additional embodiments. Accordingly, all such modifications are intended to be included within the scope of this invention.

What is claimed is:

1. A method of determining market-share trends, comprising:
specifying values for switching between pairs of a plurality of search tools for a user;
determining values for a transition matrix between the search tools from the switching values;
determining steady-state values from the transition matrix for characterizing a steady state arising from a sequential operation of the transition matrix, wherein the steady-state values characterize market-share trends for the search tools; and
saving one or more values for the steady state values.

2. A method according to claim 1, wherein the search tools include Internet search engines.

3. A method according to claim 1, wherein specifying the switching values includes keeping running counts for switches between pairs of the search tools.

4. A method according to claim 1, wherein determining the values for the transition matrix between the search tools includes scaling combinations of the switching values from a first search tool to another one of the search tools by a value for all switches from the first search tool.

5. A method according to claim 1, wherein determining the steady-state values includes calculating values for matrix multiplications of the transition matrix and calculating a steady-state condition for terminating the matrix multiplications.

6. A method according to claim 1, wherein determining the steady-state values includes calculating at least one eigenvalue and eigenvector for the transition matrix

7. A method according to claim 1, wherein saving the one or more values includes storing the one or more values in a computer-readable medium.

8. A method according to claim 1, further comprising:
specifying values for switching between pairs of a plurality of sites for a plurality of users;
determining values for transition matrices between the sites from the switching values for each of the users;
determining steady-state values from the transition matrices for characterizing steady states arising from sequential operations of the transition matrices;
determining at least one statistical value from the steady-state values between two sites for the users; wherein the at least one statistical value includes one of a mean or median value with respect to the users for transitions from the first of the two sites to the second of the two sites; and
saving one or more values for the at least one statistical value.

9. An apparatus for determining market-share trends, the apparatus comprising a computer for executing computer instructions, wherein the computer includes computer instructions for:
specifying values for switching between pairs of a plurality of search tools for a user;
determining values for a transition matrix between the search tools from the switching values;
determining steady-state values from the transition matrix for characterizing a steady state arising from a sequential operation of the transition matrix, wherein the steady-state values characterize market-share trends for the search tools; and
saving one or more values for the steady state values.

10. An apparatus according to claim 9, wherein the search tools include Internet search engines.

11. An apparatus according to claim 9, wherein specifying the switching values includes keeping running counts for switches between pairs of the search tools.

12. An apparatus according to claim 9, wherein determining the values for the transition matrix between the search tools includes scaling combinations of the switching values from a first search tool to another one of the search tools by a value for all switches from the first search tool.

13. An apparatus according to claim 9, wherein determining the steady-state values includes calculating values for matrix multiplications of the transition matrix and calculating a steady-state condition for terminating the matrix multiplications.

14. An apparatus according to claim 9, wherein determining the steady-state values includes calculating at least one eigenvalue and eigenvector for the transition matrix

15. An apparatus according to claim 9, wherein the computer further includes computer instructions for:
specifying values for switching between pairs of a plurality of sites for a plurality of users;
determining values for transition matrices between the sites from the switching values for each of the users;
determining steady-state values from the transition matrices for characterizing steady states arising from sequential operations of the transition matrices;
determining at least one statistical value from the steady-state values between two sites for the users; wherein the at least one statistical value includes one of a mean or median value with respect to the users for transitions from the first of the two sites to the second of the two sites; and
saving one or more values for the at least one statistical value.

16. An apparatus according to claim 9, wherein the computer includes a processor with memory for executing at least some of the computer instructions.

17. An apparatus according to claim 9, wherein the computer includes circuitry for executing at least some of the computer instructions.

18. A computer-readable medium that stores a computer program for determining market-share trends, wherein the computer program includes instructions for:
specifying values for switching between pairs of a plurality of search tools for a user;
determining values for a transition matrix between the search tools from the switching values;
determining steady-state values from the transition matrix for characterizing a steady state arising from a sequential operation of the transition matrix, wherein the steady-state values characterize market-share trends for the search tools; and
saving one or more values for the steady state values.

19. A computer-readable medium according to claim 18, wherein the search tools include Internet search engines.

20. A computer-readable medium according to claim 18, wherein specifying the switching values includes keeping running counts for switches between pairs of the search tools.

21. A computer-readable medium according to claim 18, wherein determining the values for the transition matrix between the search tools includes scaling combinations of the switching values from a first search tool to another one of the search tools by a value for all switches from the first search tool.

22. A computer-readable medium according to claim 18, wherein determining the steady-state values includes calculating values for matrix multiplications of the transition matrix and calculating a steady-state condition for terminating the matrix multiplications.

23. A computer-readable medium according to claim 18, wherein determining the steady-state values includes calculating at least one eigenvalue and eigenvector for the transition matrix

24. A computer-readable medium according to claim 18, wherein the computer program further includes instructions for:
specifying values for switching between pairs of a plurality of sites for a plurality of users;
determining values for transition matrices between the sites from the switching values for each of the users;
determining steady-state values from the transition matrices for characterizing steady states arising from sequential operations of the transition matrices;
determining at least one statistical value from the steady-state values between two sites for the users; wherein the at least one statistical value includes one of a mean or median value with respect to the users for transitions from the first of the two sites to the second of the two sites; and
saving one or more values for the at least one statistical value.
